(19) United States
(12) Patent Application Publication
(10) Pub. No.: US 2026/0202529 A1
(43) Pub. Date: Jul. 16, 2026

(54) SONAR-BASED UNDERWATER SENSING SYSTEM

(71) Applicant: The Chinese University of Hong Kong, Hong Kong (CN)

(72) Inventors: Zhenyu YAN, Hong Kong (CN); Haozheng HOU, Hong Kong (CN); Guoliang XING, Hong Kong (CN)

(21) Appl. No.: 19/427,128

(22) Filed: Dec. 19, 2025

Related U.S. Application Data
(60) Provisional application No. 63/745,124, filed on Jan. 14, 2025.

(51) Int. Cl. G01S 7/539; G01S 7/52; G01S 15/89; G08B 21/08

(52) U.S. Cl. CPC G01S 7/539; G01S 7/52077; G01S 7/52085; G01S 15/8993; G08B 21/08

(57) ABSTRACT

A sonar-based underwater sensing method and systems are provided. The method includes performing intermittent scanning and image reconstruction; performing dynamic noise removal and object detection; and performing multi-dimensional activity recognition. To overcome the low frame rate due to the sonar's physical limitation, a scanning strategy is developed and an image reconstruction method is applied to accelerate the scanning speed without compromising the performance of motion detection. To overcome the dynamic interferences in the underwater scenario, a signal processing pipeline based on a physical model is developed to remove noises and localize human subjects. Features such as motion, time, and spatial information are further extracted from sonar images and a state-transfer-based activity recognition system is provided. The method was implemented across three public swimming pools for a total period of 94 hours. The evaluation results show that the method successfully recognizes around 90.5% human activities in the water.

### CROSS-REFERENCE TO RELATED APPLICATION

The present application claims the benefit of U.S. Provisional Application Ser. No. 63/745,124, filed Jan. 14, 2025, which is hereby incorporated by reference herein in its entirety, including any figures, tables, or drawings.

### BACKGROUND OF THE INVENTION

### 1 Introduction

Continuous monitoring of human activities in swimming pools is vital for effective pool management, training purposes, and ensuring safety. Inadequate supervision has been identified as a major factor in aquatic incidents [14] by the US Centers for Disease Control and Prevention. Lifeguards may experience attention lapses and have obstructed line of sight (LoS) due to their positioning above the water, making it challenging to distinguish between normal behavior and potential drowning incidents. Moreover, existing solutions fail to address the need for continuous, long-term individual monitoring in many aquatic environments. Some pool management systems install cameras at the bottom of the pool [17, 29, 38, 54, 59, 63], but they are prone to being compromised by varying lighting conditions and raise significant privacy concerns from the public. To ensure the camera's LoS, they often require the deployment of multiple underwater cameras, resulting in substantial installation and maintenance expenses. Additionally, motion recognition solutions for swimmers that rely on wearable devices [23, 28, 33, 44, 47, 52] are often obstructive, intrusive and lack scalability. In summary, current solutions fail to enable continuous monitoring of human activities in water without incurring high deployment costs or invading privacy.

Sonar technology is widely used for underwater sensing, from deep ocean monitoring [13, 24, 36] to robust underwater communication. The ability of acoustic waves to propagate through water and bypass obstructions, including human bodies, makes sonar a promising sensor modality for underwater sensing. However, most conventional sonar solutions are designed for long-range sensing, which can be prohibitively expensive and potentially unsafe in swimming pool environments. Recent research has explored the use of smartphone speakers and microphones for underwater sensing [6]. Nevertheless, such devices do not possess the capability to extract the fine-grained features necessary for precise activity recognition.

Scanning sonar is an ideal solution for underwater navigation and mapping [18]. However, sensing human activities with scanning sonars faces three major challenges: First, the sonar's frame rate is limited by the physical rotation speed of the motor and acoustic echo return time, resulting in potential delays in detecting rapid activities. Second, The sonar images contain significant dynamic noises from various sources, such as water surface reflections, movements from other swimmers, and environmental factors like wind or rain. Third, activity recognition with sparse information is inherently challenging due to the limited information available for feature extraction. The 2D nature of sonar images compresses all vertical information onto a horizontal plane, complicating the extraction of 3D motion features and differentiation between similar activities.

### 2 Previous Work

2.1 Monitoring Human Activities in Water Various sensing modalities, such as vision, Inertial Measurement Units (IMUs), and acoustics, have been employed in aquatic sensing applications. Cameras have been used for swimming style detection by capturing the swimmers' motion [38, 54] and gesture recognition for underwater human-robot interaction [59], but they only work for short-range recognition under sufficient luminance. Despite swimming detection, cameras can be used to detect drowning through object detection and skeleton recognition [17, 29, 63], which is a more challenging task due to the complexity and heterogeneity of drowning.

Wearable devices equipped with various sensors have been utilized for detecting underwater activities. IMUs have been integrated into smartwatches [52], body-mounted devices [33, 44], and headgear [28] to identify swimming styles. Other sensors, like radio [23], heart-rate tracker [47] or integrated multi-sensor system [35] are also proposed to detect drowning by some pre-defined feature. However, they failed to accurately distinguish drowning from other water activities like splashing or diving due to their inability to capture full-body motion.

Compared to the above modalities, acoustics represents the promising modality for underwater detection due to relatively low attenuation underwater, which will be discussed extensively below. [58] shows several underwater machine learning applications based on acoustic data, including object detection, seafloor detection, and target classification. Specifically, previous works utilize Doppler-frequency-shift [25, 34], convolutional neural network [34] to recognize drowning but ignore the water and multi-user interferences. [22] demonstrates sonar-based drowning detection, which is the closest work to the system. However, it provides limited analysis of human activity patterns, thereby limiting the target to two basic classes that can't cover sufficient cases. Aquahelper [60, 61] build an SOS transmission system by smartwatch; although promising, it is impractical to rely on potential drowning victims to activate SOS signals.

### 2.2 Sonar and Acoustic Sensing

SOund NAvigation and Ranging (Sonar) have been extensively explored for underwater applications, which use acoustic sensing to detect underwater objects with relatively low attenuation. It has three types: side-scan, multi-beam imaging, and rotary scanning sonar.

Side-scan sonars, known for their narrow, tall beams, excel in capturing detailed images over long distances, making them effective for geological and structural mapping [5, 7, 30]. However, their fixed view and narrow beam width limit their coverage area, potentially missing nearby swimmers in a pool setting.

Multi-beam sonars mitigate this by emitting multiple beams to scan and image confined areas, commonly used for tracking underwater objects and marine life [13, 24, 36]. Yet, their constrained scan range can lead to blind spots, necessitating additional sensors and thus escalating costs.

Rotary scanning sonars, which employ a motor-driven single-beam transducer to achieve 360-degree coverage, are predominantly utilized for undersea environmental monitoring [19, 42, 43, 46]. Wide coverage and lower cost than multi-beam sonars make rotary scanning sonar suitable for human activity sensing.

Although there are various applications of acoustic sensing, including fall detection by Doppler shift [37], limbs and torso detection [4], 3D pose reconstruction with RGB images [62], localization [39, 51], finger gesture [50] and underwater localization [6], all these above techniques utilize frequency domain or phase-domain features for activity detection, requiring access to raw data. Unfortunately, the commercial sonar does not support it, which requires a new system for human activity monitoring. [24, 27] shows the potential of marine animal detection with acoustic sensing. However, these works are limited in sensing range and lack of design for multi-subject detection.

### BRIEF SUMMARY OF THE INVENTION

There continues to be a need in the art for improved designs and techniques for activity monitoring methods and system.

According to an embodiment of the subject invention, a sonar-based underwater sensing system comprises a scanning and image reconstruction unit configured for intermittent scanning and image reconstruction; a noise removal and object detection unit configured for dynamic noise removal and object detection; and an activity recognition unit configured for multi-dimensional activity recognition. The scanning and image reconstruction unit comprises a controller intermittently controlling an external sonar device to perform low latency scanning to acquire sonar images. Moreover, the scanning and image reconstruction unit comprises a background removal device configured to eliminate static noises from the solar image acquired. The scanning and image reconstruction unit comprises a signal reconstruction device configured to reconstruct the sonar images acquired to compensate for intermittent scanning. The noise removal and object detection unit comprises a median filter configured to perform removal of high-frequency noises and extracting edges from the sonar images acquired. In addition, the activity recognition unit comprises a feature extractor configured for extracting multi-dimensional features from the sonar images acquired and a monitor configured to monitor temporal states.

In another embodiment, a sonar-based underwater sensing method comprises performing intermittent scanning and image reconstruction; performing dynamic noise removal and object detection; and performing multi-dimensional activity recognition. The performing intermittent scanning and image reconstruction comprises intermittently controlling a sonar device to perform low latency scanning to acquire sonar images. Moreover, the performing intermittent scanning and image reconstruction comprises eliminating static noises from the solar image acquired. The performing intermittent scanning and image reconstruction comprises performing reconstruction of the sonar images acquired to compensate for intermittent scanning. In addition, the performing dynamic noise removal and object detection comprises performing removal of high-frequency noises and extracting edges from the sonar images acquired. The performing multi-dimensional activity recognition comprises performing extracting multi-dimensional features from the sonar images acquired and monitoring temporal states.

In certain embodiment, a non-transitory computer readable medium having stored therein program instructions executable by a computing system to cause the computing system to perform a sonar-based underwater sensing method. The method comprises performing intermittent scanning and image reconstruction; performing dynamic noise removal and object detection; and performing multi-dimensional activity recognition. The performing intermittent scanning and image reconstruction comprises intermittently controlling a sonar device to perform low latency scanning to acquire sonar images. Moreover, the performing intermittent scanning and image reconstruction comprises eliminating static noises from the solar image acquired. In addition, the performing intermittent scanning and image reconstruction comprises performing reconstruction of the sonar images acquired to compensate for intermittent scanning. The performing dynamic noise removal and object detection comprises performing removal of high-frequency noises and extracting edges from the sonar images acquired and performing extracting multi-dimensional features from the sonar images acquired.

### BRIEF DESCRIPTION OF THE DRAWINGS

FIG. 1 shows measurement setup in a public pool, according to an embodiment of the subject invention.

FIG. 2 shows working principles of the scanning sonar, according to an embodiment of the subject invention.

FIG. 3 shows scan speeds with different sonar settings, according to an embodiment of the subject invention.

FIGS. 4(a)-4(d) show four example images from a scanning sonar, according to an embodiment of the subject invention.

FIGS. 5(a)-5(f) show sonar images of six human activities, according to an embodiment of the subject invention.

FIG. 6 shows the overview of AquaScan, according to an embodiment of the subject invention.

FIG. 7 shows performance of Median Blur with variable kernels sizes, according to an embodiment of the subject invention.

FIG. 8 shows the processing pipeline of the dual-branch noise removal and objective detection, according to an embodiment of the subject invention.

FIG. 9 shows multi-dimensional finite-state machine for activity monitoring, according to an embodiment of the subject invention.

FIG. 10 shows examples of data collection in two pools, according to an embodiment of the subject invention.

FIG. 11 shows object detection and activity recognition vs. intermittent scanning parameters, according to an embodiment of the subject invention.

FIGS. 12(a)-12(d) show Confusion matrices of pool activity recognition using AquaScan and baselines, wherein the safe and dangerous values in the sub-captions show the classification accuracy of safe and dangerous activities, respectively, according to an embodiment of the subject invention.

FIG. 13 shows detection delay across activities, according to an embodiment of the subject invention.

FIG. 14 shows the effectiveness of image reconstruction, image denoising, and data augmentation, according to an embodiment of the subject invention.

FIG. 15 shows recognition performance across distances, according to an embodiment of the subject invention.

FIG. 16 shows recognition performance across swimmers, according to an embodiment of the subject invention.

FIG. 17 shows impact of object blockage, according to an embodiment of the subject invention.

FIG. 18 shows impact of swimwear, according to an embodiment of the subject invention.

FIG. 19 shows impact of sonar depths, according to an embodiment of the subject invention.

FIG. 20 shows impact of different pools, according to an embodiment of the subject invention.

FIG. 21 shows numeric results of tracking performance, according to an embodiment of the subject invention.

FIG. 22 shows classification accuracy across various subject numbers, according to an embodiment of the subject invention.

```
Algorithm 1 Search for the optimal kernel size
  Define f(x) as the clustering method, where x is the image.
  Define G(x, k) as the median blur function, where k is the
  kernel size.
  Define S(a) as the function to calculate the size of a bounding
  box a.
  Initialize kernel size k = 3, threshold Tₑ = 2.6928, where
  Tₑ is the maximum size of a bounding box representing a
  human.
  while k ≤ 17 do
    Apply median blur xₜₑₘₚ ←G(x, k)
    Cluster objects Obj ← f (xₜₑₘₚ )
    if any S(Objᵢ ) > Tₑ for Objᵢ ∈ Obj then
      k ← k + 2 { Increase kernel size}
    else
    return k {Optimal kernel size found}
    end if
  end while
  return k {Return the largest considered kernel size if no
  smaller optimal size is found}
```

TABLE 1
Activity definition.

| Activity | Description |
|---|---|
| Moving | Clear change in location |
| Motionless | Minimal change in location, low-intensity motion |
| Struggling | Continuous high-intensity motion with minimal location |
| | change |
| Splashing | Short- term high-intensity motion with minimal location |
| | change |
| Drowning | Gradual, consistent location change, typically low-intensity |
| | motion following a struggle |

TABLE 2
The values of hyperparameters.

| Parameter | Value | Parameter | Value | Parameter | Value |
|---|---|---|---|---|---|
| F̅ | 0.9 | T_{struggling} | 20 s | Tₘₒₜᵢₒₙₗₑₛₛ | 60 s |
| Rₘᵢₙ | 1.0 | Dₘᵢₙ | 0.3 m | Dₘₐₓ | 0.6 m |
| IoUₘᵢₙ | 0.5 | dₘᵢₙ | 0.3 m | dₘₐₓ | 0.6 m |
| (x/y) | ⅓ | T_{win} | 12 s | | |

TABLE 3
Detection performance of baselines, AquaScan,
AquaScan without physical-aware noise removal.

| Methods | F1-Score | MDR | IoU |
|---|---|---|---|
| AverageBlur [12] | 0.231 | 0.643 | 0.111 |
| BilateralFilter [53] | 0.167 | 0.782 | 0.016 |
| GaussianBlur [40] | 0.201 | 0.720 | 0.071 |
| MedianBlur [26] | 0.238 | 0.651 | 0.118 |
| KBNet [64] | 0.333 | 0.266 | 0.309 |
| BM3D [9] | 0.471 | 0.090 | 0.417 |
| Ours | 0.790 | 0.044 | 0.532 |
| Ours w/o PhI | 0.096 | 0.037 | 0.424 |

### DETAILED DISCLOSURE OF THE INVENTION

The embodiments of subject invention pertain to a sonar-based underwater sensing method and systems.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### 3 A Measurement Study of Scanning Sonar

According to the embodiments of the subject invention, an activity monitoring system with a new generation of sonar, called scanning sonar, is provided. Scanning sonar features a motor-driven transducer that can pivot to specific angles, allowing it to emit sound waves in a narrow beam, typically spanning 2.22 gradians (grads) horizontally and 27.78 grads vertically. With the ability to rotate the transducer through full scanning, the motor enables comprehensive scanning coverage of the swimming pool area. The output of scanning sonar is a low-resolution 2D sonar image showing the horizontal space, which also costs significantly less than the other high-end imaging sonars.

In one embodiment, AquaScan, a sonar-based underwater sensing system is developed for non-intrusive monitoring of human activity in swimming pools. The system utilizes acoustic waves to accurately detect and classify various human movements, providing an effective solution that also respects the individual's privacy. AquaScan's approach to human activity monitoring is multi-faceted, incorporating advanced signal processing techniques, state-of-the-art machine learning methods, and an innovative scanning strategy that collectively overcomes the limitations of traditional sonar systems in a pool environment. By integrating these elements, AquaScan delivers a system capable of high accuracy and real-time monitoring, offering a significant advancement in the domain of aquatic safety and pool management. The main advantages of the subject invention are as follows:
an innovative intermittent scanning strategy, which is the first to effectively balance both the frame rate and detection performance of underwater activity recognition systems, while also minimizing false detection and miss detection in object detection.
a physical-aware adaptive noise removal method that effectively filters out environmental and operational interferences, ensuring the clarity and reliability of sonar images.
an analysis of the common human activities in the swimming pool and introduce a multi-dimensional feature extraction and state-transition framework for activity recognition, capable of distinguishing between various movements and identifying potential accidents or hazardous situations.
Implementation and evaluation of AquaScan in three public swimming pools, collecting 94 hours of datal. The evaluation results show an average 90.5% accuracy for activity monitoring in 8.61 seconds. The scanning strategy increases the frame rate by 1.83 times. Compared with the existing methods, 41.4% higher accuracy is achieved.

While sonars are widely used for sensing in open aquatic environments, their adoption for accurate human activity monitoring in compact water spaces like swimming pools is still emerging. Scanning sonar equips a motor to rotate the sonar transducer for a larger coverage. This section measures its performance in a public swimming pool and analyzes its capability of distinguishing human activities in the water.

### 3.1 Scanning Sonar in Underwater Sensing

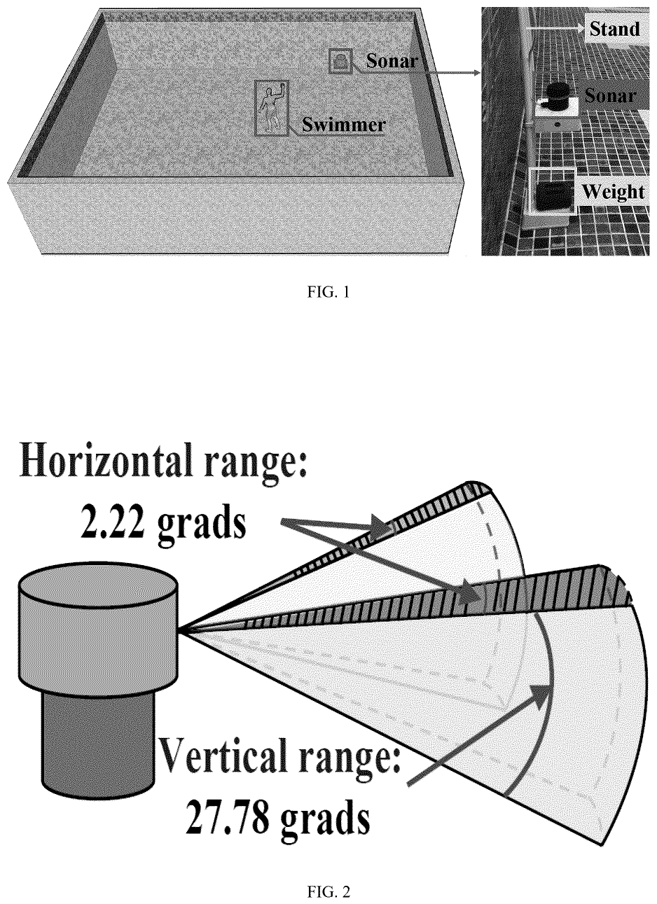

To assess the performance of the scanning sonar underwater, a sonar is attached to the edge of a public pool. FIG. 1 demonstrates the deployment setup. The sonar, deployed at 1.5 meters underwater, is connected to a Raspberry Pi using an ethernet cable to collect data.

Working Principles of Scanning Sonars. Ping360 Scanning Imaging Sonar produced by BlueRobotics [2], is chosen for the measurement study. The scanning sonar uses 5 watts of power as the Maximum Power Consumption. FIG. 2 shows the working principle of the scanning sonar. In each scan, the sonar transmits a 750 kHz acoustic wave to measure distances based on the time it takes for the signal to return. It scans a sector with a horizontal angle of 2.22 grads and a vertical angle of 27.78 grads, rotating in different directions for fully scanning all consecutive sectors. The output is a 2D greyscale image where each pixel indicates the intensity of reflections.

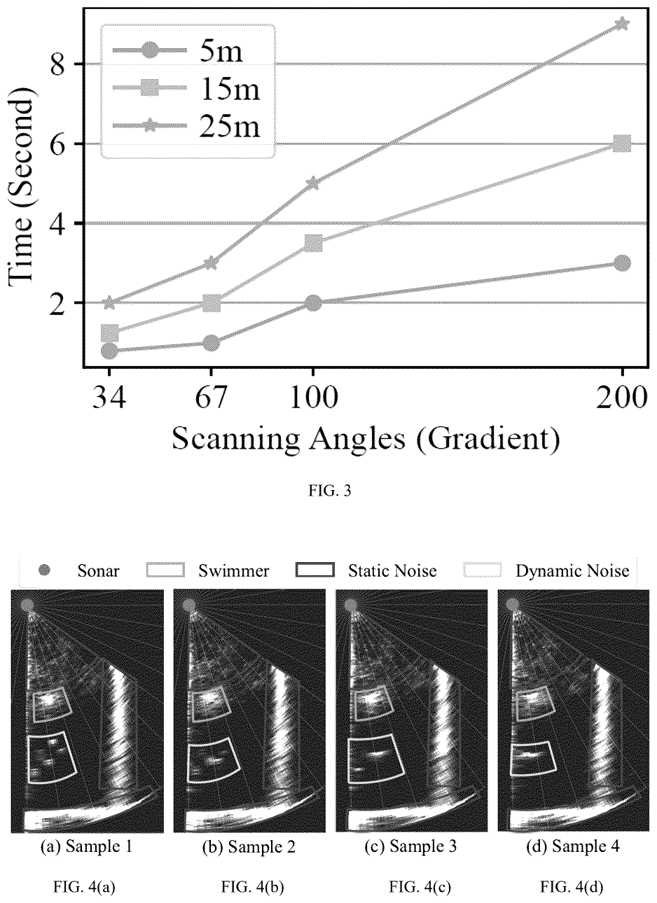

Sonar Scanning Time. The rotation speed of the scanning sonar is measured to estimate the delay in scanning the whole pool with sensing ranges of 5 m, 15 m, and 25 m and scanning 34, 67, 100, and 200 grads. As shown in FIG. 3, larger scanning areas and ranges increase the scanning time. For example, it takes the sonar 9 s to scan a pool with a 25 m sensing range and 200 grads (180 degrees) scanning area, which is 0.111 frames per second (FPS). This delay occurs as the sonar waits for acoustic echoes which causes poor tracking performance and low recognition accuracy due to capturing fewer frames per movement.

Static and Dynamic Noise in Sonar Images. presents four sonar images of a volunteer standing in a pool, each showing a 60 grads scan. The blue dot marks the position of the sonar, while the green box indicates the location of the subject. Red boxes highlight static noises caused by the edges and bottom of the pool. Yellow boxes represent random dynamic noises from sources such as water surface waves and reflections between objects and pool edges. Observations suggest that pre-scanning the background to eliminate static noises is beneficial. Some dynamic noises are less energetic and may overlap with other human subjects. Given the unpredictable nature of water movements and reflections, it is desirable to design an adaptive noise removal method to ensure accurate detection of human subjects.

### 3.2 Human Activities in the Water

Human aquatic activities can be categorized as either voluntary or instinctive. Voluntary actions, such as intentional swimming and purposeful splashing, are consciously initiated by individuals. On the other hand, instinctive actions, like struggling to remain buoyant or losing control in dangerous situations like drowning, occur involuntarily and surpass conscious control [55].

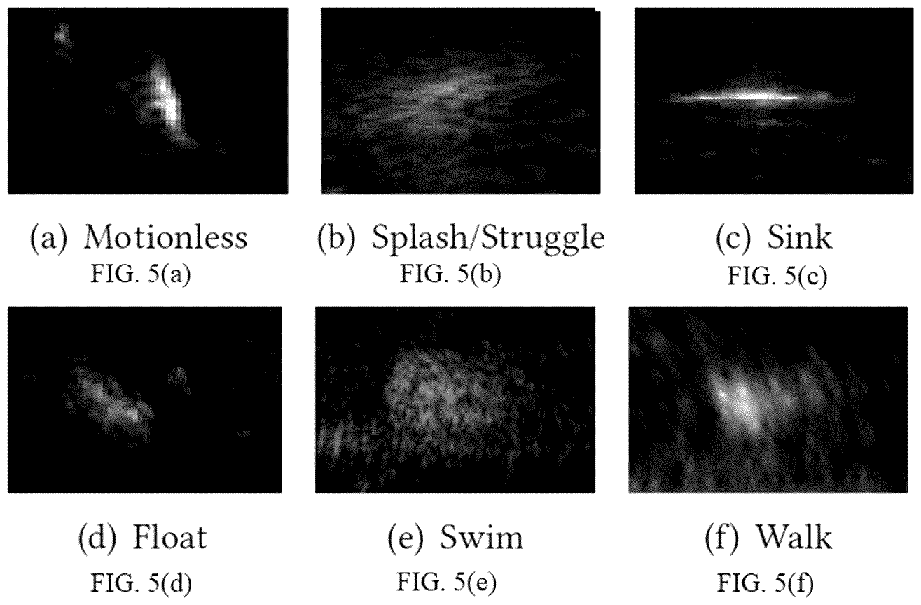

The scanning sonar data are collected when a volunteer engaged in various aquatic activities2. FIGS. 5(a)-5(f) present six sonar images captured when a volunteer is motionless, struggling, sinking, floating, swimming, and walking, respectively. The activities with minimal motion in FIGS. 5(a), 5(c), and 5(d) generate more concentrated clusters. In contrast, activities such as those in FIG. 5(b) result in larger clusters due to the increased movements. FIGS. 5(b), 5(e) and 5(f) further show that when the arms are open or waving, the image shows more scatters around the object. Even though sonar images may not clearly show poses or complex movements, it is observed that the distribution of echoes reflects the subject's motion. The body parts demonstrate higher energy in the sonar images, while the arm movements create scatters near the body signal. Splashing or struggling can be classified through dispersed echoes due to motion. Sinking, being motionless, and floating share similar features that classify them as motionless states. Given that swimming and walking lack distinctive features within one frame, obtaining the location of swimmers becomes crucial to assess subjects' movements.

Data are collected on three common activities, i.e., swimming, patting, and standing, as well as on two hazardous actions: struggling and drowning. Two deep neural networks (DNNs), which are widely used in camera-based drowning detection [17] and video activities analysis [10], are trained using the self-collected sonar image dataset. Each input sample consists of 3 consecutive frames of sonar images so that the models can capture the temporal information. Both these two models achieve low accuracy at 0.21 and 0.25.

This measurement study highlights three pivotal challenges faced by the sonar-based system: scanning speed, dynamic noise, and the recognition of complex swimming activities. Firstly, the current sonar system requires 6 seconds to scan a 200-grads area with a 15-meter range, a pace insufficient for real-time application, leading to delayed activity recognition. Secondly, the presence of dynamic noise significantly increases false positives, thereby reducing reliability and increasing the risk of false alarms. Thirdly, the diverse aquatic activities of individuals complicate accurate identification and categorization, necessitating enhanced recognition capabilities.

### 4 AquaScan Design

### 4.1 System Overview

To overcome the aforementioned challenges, AquaScan is designed to support continuous, timely, and accurate monitoring of human aquatic activities by utilizing scanning sonars with high scanning frame rates.

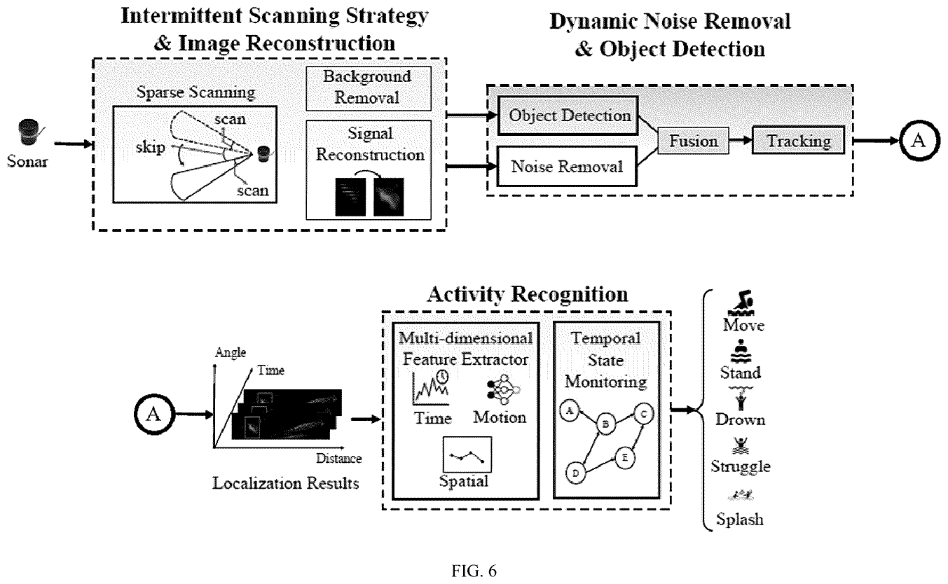

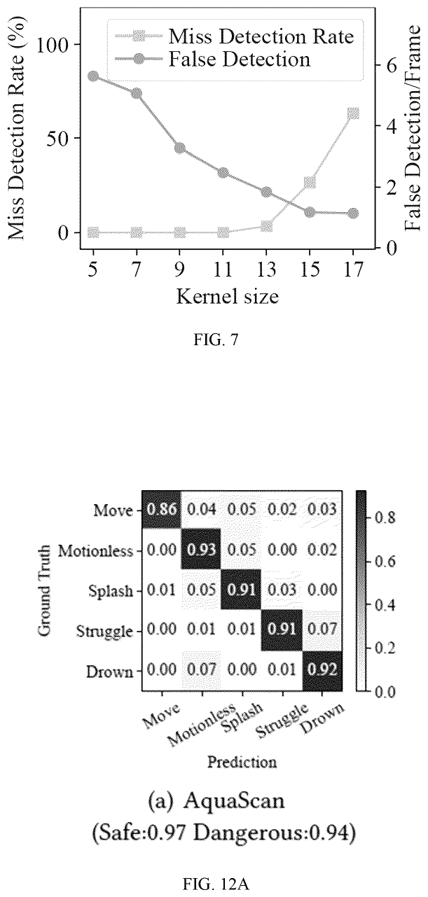

FIG. 6 shows the overview of AquaScan's design. First, AquaScan intermittently controls sonar scanning for low latency scanning. Second, AquaScan eliminates static noise and reconstructs sonar images to compensate for intermittent scanning. Then, to detect and locate human subjects in sonar images, AquaScan utilizes a dual-branch noise removal pipeline with physical information. After merging localization and detection results, AquaScan recognizes activities using a multidimensional state machine by extracting time, motion, and spatial features. The recognition includes moving, motionless, possible drowning, struggling, and splashing.

### 4.2 Intermittent Scanning Strategy and Image Reconstruction

The measurements in Section 3.1 show that a full scan with 15 meters range takes 6 seconds. This duration could potentially lead to missing the detection of critical activities. To accelerate the sonar scanning, a scanning strategy of skipping scanning angles intermittently is provided to improve the data framerate. The idea is that the sonar scans the first x consecutive grads every y grads for each image. In the rest of the paper, x/y are used to represent scanning first x gradians in y gradians.

Since the intermittent scanning strategy generates lines of empty pixels in sonar images, an image reconstruction method is provided for interpolation. Existing popular image processing methods often use deep learning (DL) (e.g., Variational Auto-encoder (VAE) [32], Unet [49], masked autoencoder (MAE) [20]) for image generation. However, these kinds of DL work well due to much redundant information in RGB images. MAE works well on images with random sampling but intermittent scanning produces block-mask images where MAE degrades performance [20]. Collecting the ground truth is hard for model training, which is also a large overhead. Thus, an efficient interpolation method that recovers skipped signals by calculating the average of the nearest existing pixels is employed.

To motivate the choice, full scan images and down sampled them are collected to simulate intermittent scanning. An Unet-shaped model [49] is trained for sonar image reconstruction due to its great capability of capturing image features and calculated the mean square error (MSE) between normalized full scan images and reconstructed images. MSE of the interpolation method is 0.256 which is lower than MSE of Unet (0.279). Considering that training a DL model requires large amounts of data, the interpolation method can achieve better performance without any data collection overhead. AquaScan also scans the background during the spare time to remove static noises, such as the pool's edges, bottom, and lane lines. This background data can also be used to offset the slight variations in scanning angles across frames caused by motor rotation.

The intermittent scanning strategy brings benefits to both object detection and recognition in three folds: (1) Skipped angles can reduce each frame's scanning time to improve the sampling rate which benefits detecting motion and motionless activities. (2) Faster scanning provides more sampling points on each swimmer's trajectory for better tracking performance. (3) The intermittent scanning strategy can skip slender noise to reduce false detections.

### 4.3 Dynamic Noise Removal and Object Detection

In the measurements described in Section 3.1, dynamic scattered noise has been observed in the sonar images, varying over time. To mitigate this issue, a median filter [26], an effective noise-reduction method is implemented to remove high-frequency noise and extract edges, which works by replacing the central pixel in a kernel with the median value of the surrounding pixels. A crucial aspect of median filtering is the choice of kernel size that determines the number of pixels for calculating the median value used in averaging each pixel. To further understand the effect of varying the median filter's kernel size, the median filter is applied on the dataset used in Section 3.2. The results in FIG. 7 show that an increase in kernel size correlates with a reduced false detection rate but can cause a higher miss rate due to the stronger denoising effect, which may inadvertently remove important features of subjects. A smaller kernel size, however, preserves the clusters of subjects more effectively but also retains a greater amount of noise. This presents a significant challenge for subsequent object detection tasks. Especially, when the kernel size is larger than 13, the miss rate increases dramatically. This is the kernels over 13 will smooth the subject with extra surrounding information and decrease the size. Hence, it is desirable to adopt two kernel sizes to achieve both dynamic noise removal and object detection.

Based on the experiments with various kernel sizes using the median filter, a dual-branch method is developed for both noise removal and object detection. The processing pipeline of this method is illustrated in FIG. 8. The approach initially focuses on eliminating weak echoes that are likely to be noises and overlap with the clusters representing swimmers. Subsequently, median filtering with two distinct kernel sizes is employed: one tailored for object detection and the other for dynamic noise removal. A search method is used to determine the kernel sizes at runtime. The final step is to integrate the results from both branches, yielding sonar images annotated with bounding boxes that identify human subjects. It is important to note that the methodology incorporates prior knowledge about typical human dimensions in both the object detection and the results fusion process.

For noise removal and object detection, a pre-process is implemented for removing the scattered echoes that mix nearby subjects or generate fake subjects. Different thresholds are set for different distances to fit the attenuation of the acoustic. Note that different thresholds should be set accordingly for tests in new swimming pools and deployment positions. Then the sonar images are upscaled from a resolution of 400×500 to 1200×1500, allowing the density based clustering methods to more effectively differentiate between clusters. It is worth noting that image resizing is beneficial for object detection only when the noise has been adequately reduced. Excessive noise can cause nearby clusters to merge, resulting in a higher false positive rate.

### 4.3.1 Physical-Aware Dynamic Noise Removal

To optimize parameters for the median filter, a search strategy leveraging prior knowledge of the human body size is provided. This knowledge imposes a significant constraint on generated bounding boxes, as noise typically exhibits abnormal shapes and sizes, such as occupying too large or too small areas. A physically-aware adaptive tuning method as shown in Algorithm 1 is provided. By incorporating physical knowledge, the median filter is tailored to be adaptive for each image.

The adaptive pipeline is designed to preserve the clusters of human subjects. Thus, a small kernel size is first selected. If the generated bounding boxes exceed the body size threshold, it indicates that the method's noise reduction is insufficient, leading to subjects merging with noise. As the kernel size increases, improved noise reduction capabilities facilitate the removal of noise and clearer delineation of subject cluster boundaries. Kernel size incrementation stops once all bounding boxes conform to the physical constraints, with a maximum kernel size limit set at 17 to inhibit excessive loss of information and high latency. The threshold (Tₑ) represents the estimated maximum size of a human body. Assuming a person lying flat on the water's surface, the area is calculated as height times width. Given an assumed height of 2.72 m [57] and a waistline of 3.02 m [16], the width, considering the human body as an approximate cylinder, is about 0.99 m. However, in real-world measurements, humans do not occupy such large areas, so this figure serves as the upper limit for the bounding box size. This maximum area is converted into a bounding box size threshold. Theoretically, the bounding box size for a human object decreases with increasing distance from the sonar, making the maximum threshold applicable. The minimum sizes of bounding boxes are also estimated by measuring them at different distances, finding that all swimmer clusters span more than 5 gradians (angle threshold) and exceed 30 cm in width (width threshold). Bounding boxes failing to meet these angle and width thresholds are considered noise.

### 4.3.2 Cluster-Based Object Localization and Bounding Box Generation

A clustering method DBSCAN [11] is applied to localize the targets on the image, which groups together data points that are closely packed while effectively identifying outliers as noise. Real-world parameters such as the diameter of humans' occupied area are utilized as the reference to determine the parameter of DBSCAN, which can be fine-tuned during the deployment. After Obtaining the bounding box for the cluster, the amplitude-weighted average coordinates are calculated as the location of the body. Next, the filtered bounding boxes generated through object detection part (denoted as (a)) and dynamic noise removal part (denoted as (b)) will be merged by iteratively comparing the Intersection over Union (IoU) of bounding boxes from (a) and (b). Those with an IoU larger than 0.4, which is an experimental value, will be merged. If no bounding boxes can be matched, keep the bounding boxes generated from (a) since keeping all the potential swimmers is more important than removing noise. One concern is if (b) misses objects, bounding boxes merging cannot be performed. In nearly all cases, if swimmers are missed, noise and other rest correct clusters are removed, or there is a lower IoU with bounding boxes from (a) due to excessive denoising ability.

4.3.3 Dynamic Coverage with Object Tracking

AquaScan tracks each subject by predicting the potential locations of each trajectory. Distinguishing the specific subject from other nearby subjects is hard. To maintain the trajectory's correctness when mismatching the wrong subjects, Multiple Hypothesis Tracking (MHT) [31] is applied and each trajectory and subject is processed based on the number of nearby subjects and trajectories. First, the trajectory trees are split into related trees and non-related trees according to whether there are nearby subjects. Similarly, subjects are split into related subjects that can be matched with nearby traces, and non-related subjects that will be seen as new traces due to failing to match related traces. Next, trajectories are matched with unique matched subjects. For the remaining subjects and trajectories, a scheme is developed based on N_{trace} and N_{subjects} (N means number of trajectories or subjects). When N_{trace}≥N_{subjects}, it is assumed that each subject can be uniquely assigned to a trajectory. Therefore, the distance between the subjects' locations and the predicted trajectories' locations is first evaluated. When N_{trace}<N_{subjects}, the nearby subjects are allowed to share one trajectory.

### 4.4 Multi-Dimensional Activity Recognition

In the system, the aim is to detect three safe activities: motionless, moving, and splashing. Two dangerous activities: struggling and drowning, are also detected. The selection and definition of these activities are extracted from the guideline in [8]. The features distinguishing each activity are detailed in Table 1. Moving shows a clear change in location. The activities of minimal movement and motion are categorized together under the motionless class. Splashing is characterized by vigorous motion in the water while still maintaining control for a limited duration, unlike struggling, which also involves intense motion but suggests a loss of control. Drowning is typically a state that ensues struggling or long-term motionless such as drowning caused by drunkenness.

Challenges. The human aquatic activities are highly diverse, which degrades the performance of the end-to-end DL model. For example, splashing and drowning are similar in a short time but have different development in a long time. Sonars deployed at different pools are set as different scanning ranges and distances, which can lead to unpredicted frame rates. To solve these two challenges, a three-dimensional feature extractor is provided to extract the stable spatial, temporal, and motion features for each subject. A finite-state machine is designed for feature smoothing and long-time activity inference.

To enhance the recognition of daily activities and potentially dangerous situations, features from three domains: motion, temporal, and spatial are integrated. The approach diverges from other activity recognition tasks that typically employ complex deep learning models. Instead, low-dimensional signals capturing motion, temporal, and spatial features are utilized, allowing construction of a definitive state transition graph to deduce the activities. This methodology enables the system to monitor swimmers effectively, offering superior generalization capabilities and more transparent physical interpretability.

It is noted that the definition of drowning in this paper serves as a reference, which can be customized according to various factors such as environment, pool settings, and users' requirements. AquaScan is designed to capture essential aquatic human features for recognizing a range of activities, accommodating a broad spectrum of use cases.

4.4.1 Motion features. The measurements show that one human subject consists of echoes from the body and limbs. Their temporal change of shapes and sizes is indicative of the motion status, which is not affected by human diversity. A ResNet-18 [21] model is used to discern these features and determine if a person is engaged in vigorous activity by analyzing three consecutive frames. The model is trained with full-scan images and augmented images generated by simulating intermittent scanning to make the model capture the sonar global and local features better. This approach strikes a balance between information sufficiency and sensing delay. The model predicts whether the objects are in still or motion.

4.4.2 Spatial features. To categorize activities as moving, motionless, or splashing, patterns of movement are examined. The first step is to distinguish between moving and motionless states, which is usually achieved by tracking objects and measuring their location changes. However, struggling and splashing can also cause minor shifts in location, which may be mistaken for movement when only considering overall changes. Therefore, a more precise analysis of movement is needed. Inspired by K-means [41] for improved spatial feature extraction, an object's multiple locations in past sonar frames are tracked. The centroid of a swimmer's positions over a time window T_{window}, and the mean distance d from the centroid to the swimmer's locations are computed. A larger d indicates significant location variation within T_{window}. The accumulated distance D, the mean distance d, the ratio R of D to d indicating movement direction, and the IoU of consecutive bounding boxes are evaluated. Thresholds Dₘₐₓ, Dₘᵢₙ, dₘₐₓ, dₘᵢₙ, Rₘᵢₙ, and IoUₘₐₓ are set to categorize movement. Objects with an IoU above IoUₘₐₓ and D and d below Dₘᵢₙ and dₘᵢₙ, respectively, are deemed stationary. Conversely, a d greater than dₘₐₓ signifies apparent movement. Swimmers are marked as moving if D exceeds Dₘₐₓ and R surpasses Rₘᵢₙ, indicating a definitive movement trend.

4.4.3 Time-domain features extraction. To refine the distinction between splashing, struggling, and drowning, time-domain features are incorporated. The process starts with arranging the motion states in chronological order, then calculate the average duration of continuous motion, denoted as Fₘₒₜᵢₒₙ. As previously established, individuals in danger often exhibit uncontrolled and persistent attempts to stay afloat. Therefore, a lower Fₘₒₜᵢₒₙ suggests better body control and a reduced likelihood of struggling. Conversely, a higher Fₘₒₜᵢₒₙ indicates a greater probability of struggle. To calculate Fₘₒₜᵢₒₙ a list of motion detection results is maintained within a time window that is suggested not to exceed 30 seconds and can calculate the ratio of current motion in this window. Drowning is typically a sequential state of struggling. Thus, when the confidence for motionlessness surpasses that for motion following a struggle or the struggling is maintained above a threshold T_{struggling}, it is transitioned to a state of drowning. Informed by lifeguard insights, children's drownings can be deceptively tranquil; hence, a rule-based link is implemented between prolonged motionlessness and drowning. If motionlessness persists for an exceedingly lengthy period Tₘₒₜᵢₒₙₗₑₛₛ, it is also classified as drowning.

### 4.4.4 Finite-State Machine for Activity Monitoring

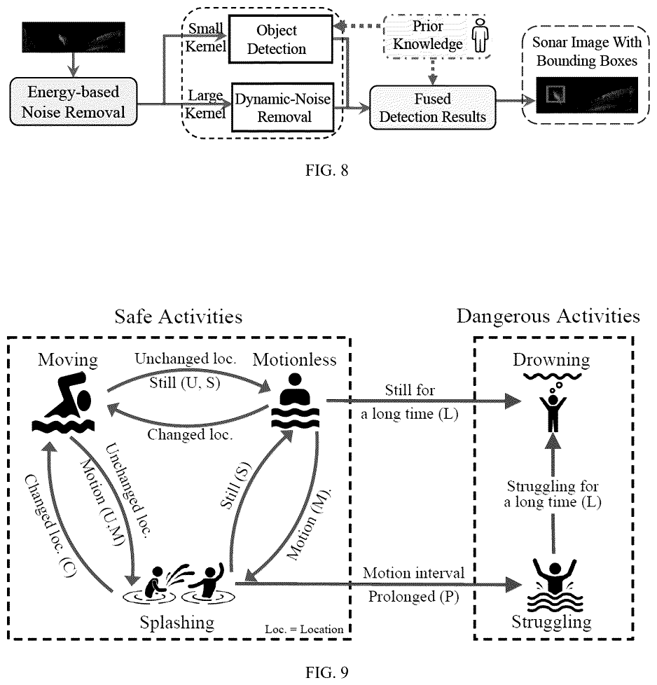

This section details the process of monitoring states and outlines the feature extraction for motion, temporal, and spatial aspects. The starting point will only be given splashing and motionless due to lack of spatial features. The collected images are processed through a multi-dimensional feature extractor, yielding four indicators: (1) Location changed (C) or unchanged (U), (2) In motion (M) or still (S), and (3) maintain one activity for a long time (L) or prolonged interval of motion (P). These indicators inform the transitions within the finite-state machine depicted in FIG. 9, enabling the progression from one state to another. To mitigate the impact of performance fluctuations on continuous activity monitoring, a sliding window-based majority voting is applied with a 10-second time window, accommodating no more than 5 frames. Utilizing a voting approach is justified by the objective to track activities over time, where sustained states provide significant insights.

### 5 Evaluation

AquaScan are extensively evaluated in real-world environments. First, the implementation details, evaluation setup, metrics, and baselines are presented. Then, the hyperparameter settings for AquaScan are described. Following that, the results of an end-to-end evaluation experiment are displayed. Subsequently, the performance of the scanning strategy and object detection is assessed. Finally, AquaScan's performance under various impact factors is demonstrated.

### 5.1 Implementation and Experiment Setup

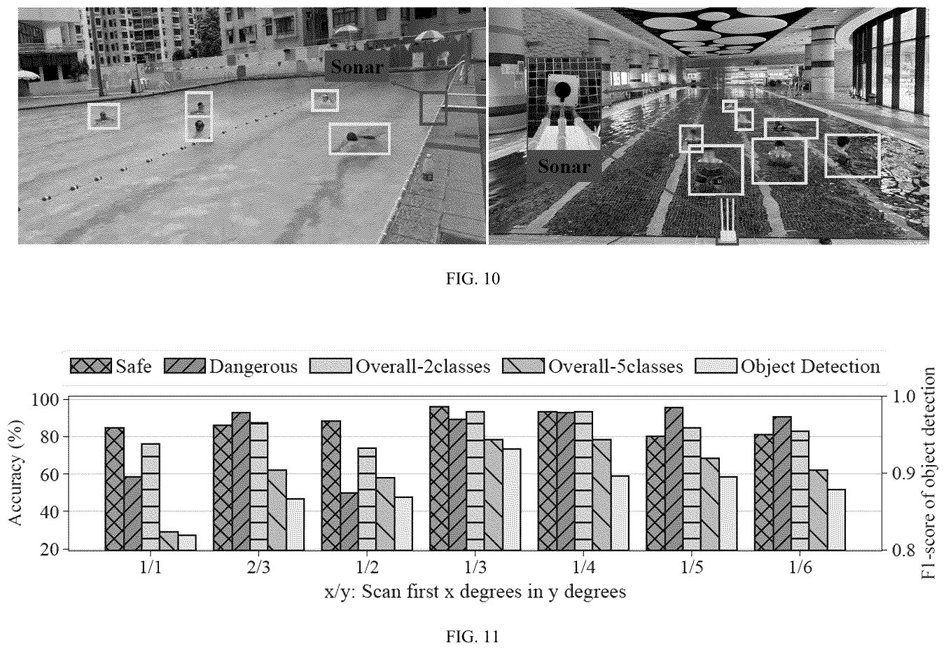

Hardware. AquaScan system is deployed with one or multiple Ping360 sonar units [1] introduced in Section 3.1. FIG. 10 shows two example deployments. Each sonar unit is connected to a processing unit above water via a Gigabit Ethernet cable. This processing unit includes a Raspberry Pi 4B with 8 GB RAM, which streams the data to the server using Wi-Fi for storage and further analysis. The server runs on an Intel Core i9-13900KF CPU and an Nvidia RTX 4090 GPU. Software. The AquaScan software is implemented with Python for data processing and sonar control. The code leverages Numpy and OpenCV for preprocessing sonar data and object detection, respectively. The recognition model of pool activities is trained using PyTorch library 1.13.0 (version number) [45]. Resnet18 whose size is 44.8 MB is trained for motion detection. This compactness ensures the practicality of deploying the solution in real-world scenarios. Open-sourced the codes are shown in [3].

Setup of Data Collection. One or two sonars are deployed in three public pools: a 25 m×9 m pool (Pool A) designated for training and validation, and two larger pools, 30 m×15 m (Pool B) and 50 m×25 m (Pool C), used for testing. In Pool A and B, the sonar was placed at the midpoints of the shorter edges, while in Pool C, it was positioned 10 m from the short edge along the longer side. Over 10 volunteers are recruited for training data collection in Pool B and 18 subjects for evaluation, with a maximum of 10 concurrent subjects whose heights vary from 173 m to 190 m, weights from 65 kg to 82 kg. In addition, two volunteers, who had previous drowning experiences, provided valuable suggestions. The volunteers' swimming skills cover novices, skilled amateur swimmers, and professional swimmers including lifeguards. Note that only skilled swimmers simulated movement, struggling and drowning. Volunteers performed activities (as detailed in 4.4) to serve as ground truth labels. They were positioned at various distances to simulate different levels of crowdedness, with some volunteers out of line of sight to mimic real-world deployment scenarios. RGB cameras are set up poolside to record their ground truth locations. 20 training sessions are conducted over 18 months (from September 2022 to August 2024), taking around 3 hours each and featuring different activity combinations and localizations, with a professional lifeguard present for safety. The endeavor resulted in the acquisition of 94 hours of training data, encompassing approximately 39,000 sonar images, predominantly featuring sessions with fewer than 5 individuals. The evaluation was conducted across Pools A, B, and C, yielding a total collection of 450, 975, and 540 images respectively.

### 5.2 Evaluation Metrics and Baselines

Various quantitative metrics are used to evaluate the performance of object detection and tracking. Several state-of-the-art methods are deployed for activity recognition.

Detection of Human Subjects. Object detection is assessed using three popular metrics, i.e., F1-score, miss detection rate (MDR), and intersection over union (IoU). F1-score is the harmonic mean of precision and recall rates, which considers both false detection and the miss rate in object detection. MDR describes the ratio of missed bounding boxes to the total number of bounding boxes. IoU represents the ratio of the area of overlay (AoO) to the area of union (AoU) between predicted and ground truth bounding boxes.

Tracking. Three metrics are used for evaluating tracking's performance, i.e., frame rate per second (FPS), and tracking rate (TR). FPS reflects the sonar scanning speed. TR reflects the tracking's performance by TR=N_{correct}/Nₐₗₗ, where N_{correct} and Nₐₗₗ represent the successfully tracked frames and the total frame number, respectively.

Recognition. The accuracies of individual activities of five classes and combined activities as evaluation metrics are used. The moving, motionless, and splashing as the “safe” classes and the rest classes (i.e., struggling and drowning) as the “dangerous” classes are combined.

Baselines. Five typical image-denoising baselines are deployed to evaluate the denoising method of AquaScan: AverageBlur, BilateralFilter, GaussianBlur, MedianBlur, and BM3D [9, 12]. Besides, the method is compared with the state-of-the-art end-to-end image denoising algorithm, i.e., KBNet [64].

Two baseline methods of image object detection are deployed since it is similar to the problem setting: One is the YOLOv5 [17] while the other is YOLOv10 [56] which has a better precision and latency. YOLOv10m and YOLOv5m, which balances latency and accuracy, are selected. Except for one-stage object detection, another baseline based on a convolutional recurrent neural network (CRNN) in [10] is implemented, which can extract spatial and temporal information about human activities. 3 consecutive frames are used as the input for all baselines and AquaScan's recognition models.

### 5.3 Hyperparameter Settings

Table 2 summarizes AquaScan's hyperparameter setting. Fₘₒₜᵢₒₙ is set to 0.9 with a time window of 30 s. T_{struggling} is set to 20 s according to the guidelines in [8]. Tₘₒₜᵢₒₙₗₑₛₛ is set as 60 s to show the ability of recognizing quite drowning. The remaining parameters (i.e., T_{win}, Rₘᵢₙ, and IoUₘₐₓ) were determined based on the collected training data.

Various settings (i.e., x/y) of AquaScan's intermittent scanning are evaluated in Section 4.2. FIG. 11 illustrates the recognition accuracy of intermittent scanning from full (i.e., 1/1) scan to 1/6 scan.

Increasing the number of skipped angles can enhance the frame rate, which improves performance in dangerous scenarios involving significant movement. Specifically, the results indicate that 1/1, 2/3, and 1/2 perform poorly because they cannot maintain the right traces. Increasing the number of skipped angles shows a decline in recognizing safe activities due to missed object detections, as indicated in the results of 1/3, 1/4. In conclusion, the 1/3 configuration achieves the highest detection accuracies across all the metrics, so AquaScan adopts the 1/3 setting for intermittent scanning.

### 5.4 An End-to-End Evaluation

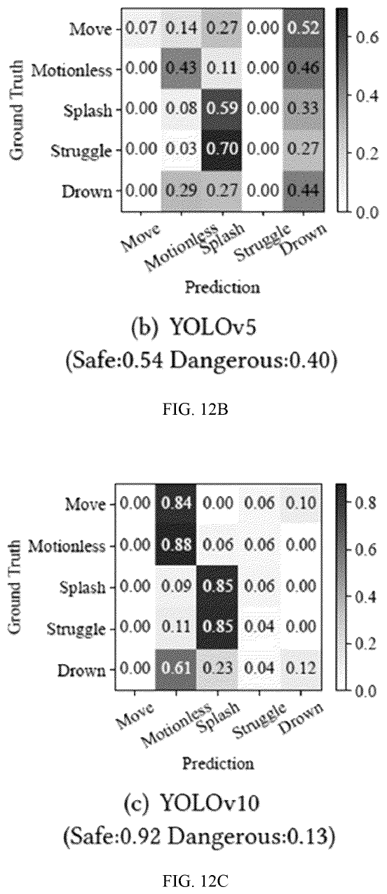

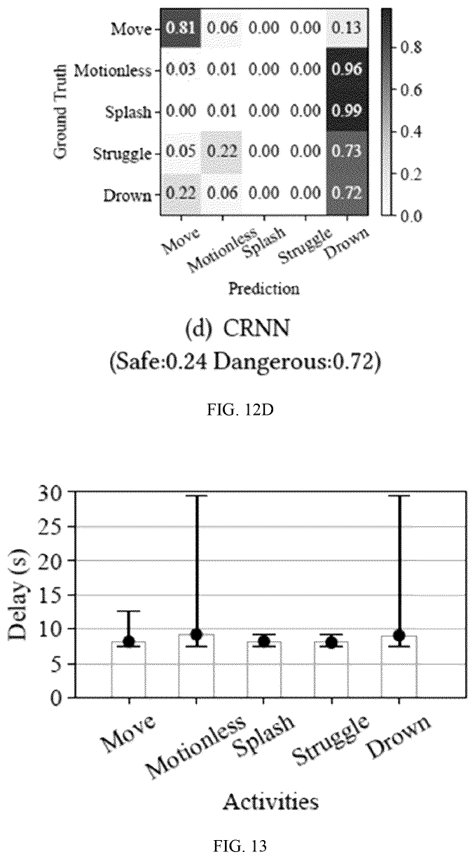

To evaluate the end-to-end performance of AquaScan against baselines, ten and five volunteers are recruited in Pools A and B at the same time, respectively. Each volunteer conducted one or multiple activities at various locations during each data collection session. FIGS. 12(a)-12(d) depict the confusion matrices of classification performance of AquaScan and baselines among five pool activities. Note that FIG. 12(d) is tested on the data AquaScan achieves an accuracy of 90.5% for five-class recognition, detecting 97% of safe and 94% of dangerous activities, outperforming all baselines. In contrast, baseline methods exhibit suboptimal performance: YOLOv5 and YOLOv10 exhibit significantly lower overall performance (35.2%, 49.1%) for five-class recognition due to their inability to extract temporal information, leading to poor performance in swimming, struggling, and drowning. Notably, YOLOv10 recognizes only 13% of dangerous activities. The CRNN achieves an overall accuracy of 31.4% for five-class recognition and 42.1% and 53.5% for safe and dangerous activities, respectively. While CRNN excels at extracting temporal features in motion-related activities, it cannot extract the spatial and time-domain features as AquaScan does, causing numerous false alarms and reduced practical utility. In summary, YOLOv5, YOLOv10, and CRNN prove less effective for this application due to their limitations in extracting relevant features from sonar images for accurate activity recognition.

AquaScan's latency of activity recognition is evaluated. The average overall latency is 8.61 seconds (s), comprising 2.79s for sonar scanning and 2.24 s for computation. FIG. 13 illustrates the detection latency for five activities, revealing that 90% of activities are detected within 10 seconds, 95% within 16 seconds, and all within 30 seconds. According to [8], drowning typically lasts 20 to 60 seconds. Given these timeframes, the observed detection latencies fall within acceptable limits, providing lifeguards with adequate time to be alerted and respond during critical drowning moments.

### 5.5 Evaluation of Image Reconstruction

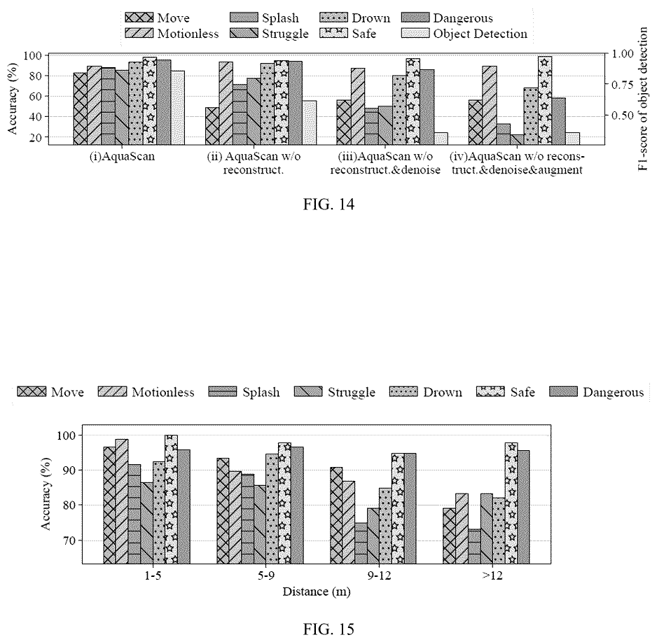

To evaluate the effectiveness of AquaScan's image reconstruction in Section 4.2, AquaScan's recognition model using raw sonar images with incomplete angles is trained. FIGS. 14(i) and (ii) show that without image reconstruction, AquaScan's detection and recognition accuracy suffer. FIG. 14(i) shows that dangerous activities due to recovered key features are effectively recognized, while FIG. 14(ii) shows subjects are missed, leading to poor tracking and recognition performance. In addition, FIGS. 14(iii) and (iv) also show that AquaScan without physical-aware denoise and data augmentation of training data exhibits significant performance degradation in activity recognition, respectively.

### 5.6 Evaluation of Object Detection

The performance of AquaScan's object detection module is further tested against various baselines. First, four classic methods and two advanced methods (KBNet [64] and BM3D [9]) are implemented to evaluate denoising methods. Averageblur, BilateralFilter, Gaussianblur, and Medianblur are four classic methods that smooth images by a kernel-wise filter for high-frequency noise removal and edge extraction. BM3D is a popular block-wise method for image noise removal and KBNet is a state-of-the-art learning-based image denoising method. Table 3 shows the performance of the baselines and AquaScan. AquaScan surpasses all baselines, yielding the highest F1-score (0.79) and IoU (0.532), with a low miss rate (0.044). While image blur methods reduce noise, they struggle with extremely noisy images. BM3D, optimized for Gaussian noise, underperforms with water induced reflections. KBNet, designed for RGB images, fails to generalize to sonar data.

An ablation study is also conducted to present the significance of AquaScan's prior physical knowledge. The system obtains a low F1-score (0.096) without physical prior knowledge since it cannot adaptively denoise the echoes that cause large false detection. The object detection is validated with different crowdedness, where the gap between humans is 0.5 m, 0.6 m, 0.7 m, and more. AquaScan misses 28.7% subjects due to signal overlaps with 0.5 m gap and detected 98.3% and 100% subjects with 0.6 m and ≥0.7 m.

Tracking. The baseline performance (full scan images) and the proposed scanning strategy from the tracking perspective in real-world experiments with 5 subjects are compared. The TR of AquaScan is 95.5% TR while the naive scan is 75.4%. The FPS of AquaScan is 0.296, while the naive scan is only 0.162. The method outperforms in both two metrics since a higher sampling rate and F1-score benefits matching detected objects and existing trajectories.

### 5.7 Impact Factors

Performance Across Various Regions. Distance between swimmers and sonars affects the performance since echoes attenuate through propagation, which decreases the accuracy of activity recognition. FIG. 15 shows the accuracy at different distances (1-5 m, 5-9 m, 9-12 m, and >12 m) between subjects and sonar. Subjects in far regions suffer from weaker signals so the accuracy of 5 classes decreases. Dangerous activities observed the activities during a time slot are less affected. Moving, motionless, and splashing are mixed, which does not degrade safe activity recognition.

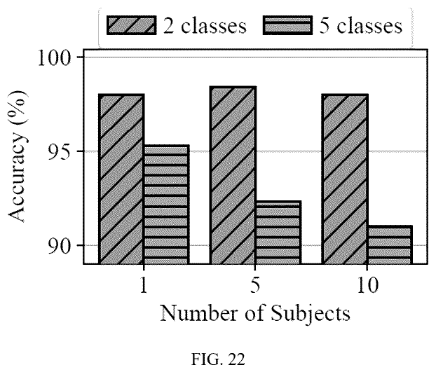

Number of Swimmers. The impact of different swimmer numbers in the pool through both numerical and real-world experiments is evaluated. A simulation method that can randomly initialize subject positions and simulate movement with random speed and direction changes is developed. The sonars are simulated to obtain the locations of subjects asynchronously. FIG. 21 shows the tracking rate (TR) under different x/y and number of subjects. As x/y decreases, TR increases due to more sampling points per trajectory, enhancing accuracy. Even with 133 subjects in a crowded pool, about 54% can be tracked correctly. In addition, 2-class and 5-class activity recognition with 1, 5, and 10 subjects in the pool from real-world experiments are evaluated. Results in FIG. 22 show that accuracy for five classes decreases due to inter-subject interference. The number of subjects has minimal impact on overall 2-class activity monitoring accuracy.

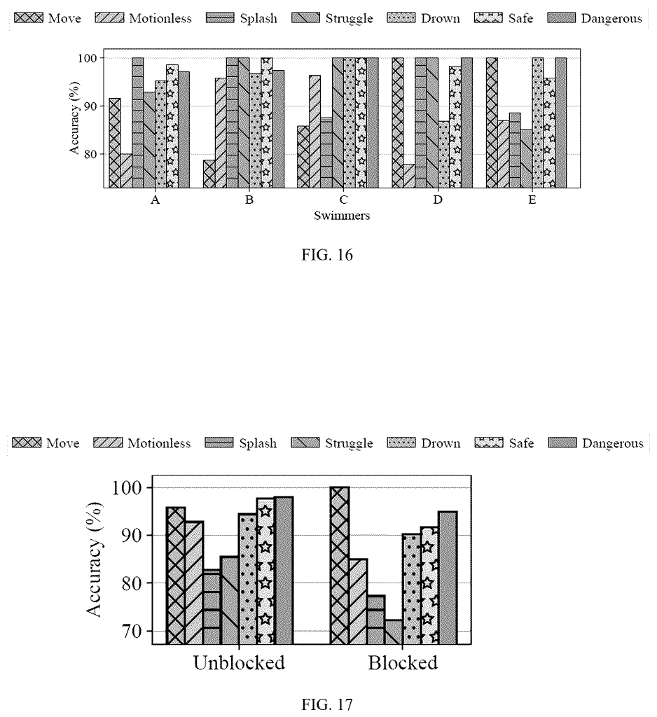

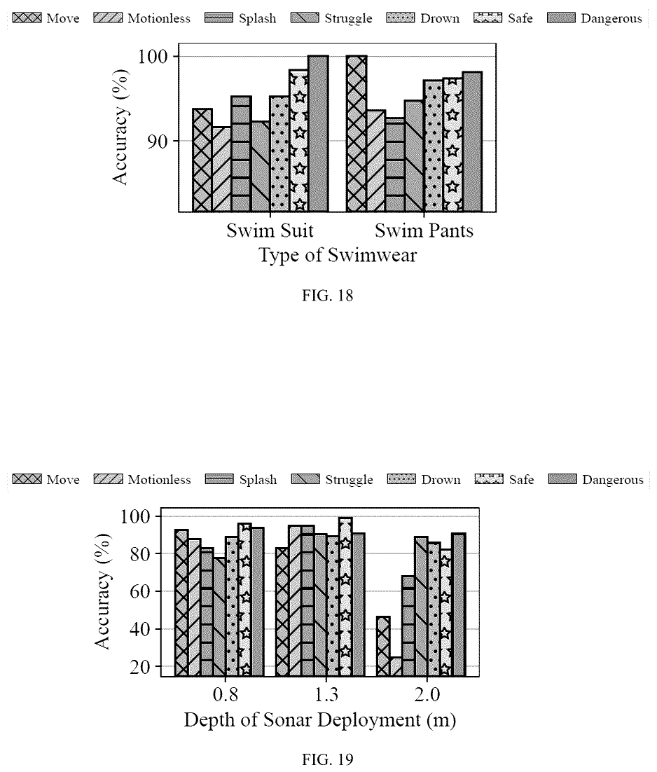

Performance Across Diverse Body Shapes. 5 swimmers are recruited with varied body shapes which can represent the body shapes in the evaluation dataset: A (177 cm 78 kg), B (177 67 kg), C (173 cm 60 kg), D (182 cm 80 kg), E (188 cm 83 kg). The result in FIG. 16 shows that although different users may have diverse performances, AquaScan can still achieve more than 95% accuracy for detecting safe and dangerous

Performance with Occlusion. Occlusion is a major concern in an acoustic sensing system. Thus, the performance is tested when the subjects are blocked (by another volunteer) or unblocked. The accuracy of splashing and struggling decreases to 77.3% and 72.2% due to weak reflections from blocked subjects. AquaScan achieves 91.7% and 94.9% for safe and dangerous activity detection, which indicates it can work for pool monitoring.

AquaScan is tested with swimmers wearing full-body and partial swimsuits. One subject performed activities at varying distances in Pool B, both in swimsuits and swim pants. Four additional subjects acted as typical swimmers. We conduct experiments with sonars deployed at 0.8 m, 1.3 m, and 2.0 m depths. FIG. 19 shows that the accuracy for safe activities drops to 82.3% due to weak echoes from partially covered subjects. Splashing and struggling cause intense water disturbances, leading to better detection of these activities. Hence, it is recommended to deploy the sonar at 0.8 m or 1.3 m.

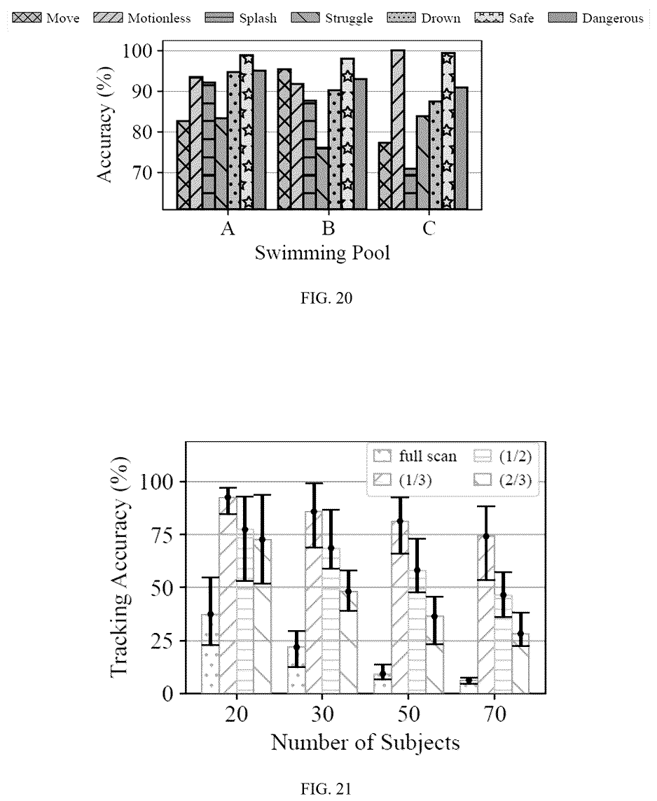

Performance in Different Pools. To show the generalization of the swimming pool, AquaScan in Pool A and Pool B with concurrent 5 subjects is tested. Due to weather and rules, only 1 volunteer in Pool C is finally recruited. The results in FIG. 20 indicate that the pool has little influence on the performance of dangerous activities (at least 90.9% in Pool C), which is acceptable for swimming pool monitoring.

Swimming Strokes. To verify that AquaScan can recognize moving subjects with different strokes, 4 swimmers as interferences and 1 swimmer are recruited to conduct four breaststrokes, backstrokes, crawl strokes, and butterfly strokes. Performances for 4 strokes are 86.7%, 88.5%, 93.3%, and 90.3% respectively. None of the moving is misclassified into dangerous activities. Swimmers of breaststroke and backstroke have relatively low performance since they do not conduct intense motion like the other two strokes.

### 6 Discussion

Multi-Sonar Collaboration for Larger Pools. A multi-sonar strategy for larger areas such as 50-meter pools can be adopted when a single sonar's coverage is limited. A collaborative approach by which multiple sonars enhance coverage and detection accuracy through co-denoising and co-localization may be developed. By comparing the paths detected by multiple sonars, objects can be differentiated from noise. High cosine similarity and short Euclidean distance between paths can confirm the detection of the same object, improving accuracy in large pool areas.

Safety of ultrasonic sonars. According to Canadian authority [48], an underwater ultrasonic imaging device should satisfy thermal index (TI)<1.5; mechanical index (MI)<1.9, and spatial-peak temporal-average intensity (I_{SPTA})<720 mW/cm² for safety. The scanning sonar adopted by AquaScan uses the power of 5 watts [1]. The thermal indexes of a baby and an adult are 0.73 and 0.35, respectively, which are more than 2 times less than the standard. This means that 1.3 hours and 2.87 hours of continuous exposure are safe for a baby or an adult, respectively. Note that the actual scanning time is only 11% of the duration in each sonar image because of intermittent directional scanning. The mechanical index is 9.14×10⁻⁵, which is 20,000 less than the requirement. The scanning area at 1 m in front of the sonar is 232 cm² such that I_{SPTA} as 21 mW/cm² can be calculated. In summary, the ultrasonic sonar used by AquaScan fully complies with the existing safety regulations.

Maximum Number of Subjects. It is assumed that each person occupies at least 1.14 m² for separate detection (see Section 5.6). In a pool measuring 50 m×25 m, over 1000 swimmers, which is theoretically extremely crowded, can be detected. Considering blockage, AquaScan can still detect at least 200 subjects in the pool.

Detection for Children in the Pool. Detecting young children poses challenges for AquaScan due to their smaller body sizes. Assuming a 2-year-old child swims 15 m from the sonar, their typical waist is 42.4 cm [15], making the body trunk at least 13.5 cm wide, occupying 1.13 grads. With the sonar's horizontal width at 2.22 grads, the (1/3) scanning scheme skips only 0.78 grads, ensuring the baby's trunk is detected. Additionally, the movement of their body and arms generates a larger dataset over time, enhancing detection.

According to the embodiments of the subject invention, AquaScan, a scanning sonar-based underwater sensing system for human activity monitoring in swimming pools is provided. AquaScan features an innovative intermittent scanning strategy, physical-aware image denoising, and a multi-dimensional feature extraction and state-transition framework for activity recognition. Field tests in public pools demonstrate AquaScan's high accuracy (90.5%) and real-time performance (8.61 seconds), offering an effective solution for aquatic safety and pool management.

### Exemplary Embodiments

Embodiments of the subject invention include, but are not limited to, the following exemplified embodiments:

Embodiment 1. A sonar-based underwater sensing system, comprising:
a scanning and image reconstruction unit configured for intermittent scanning and image reconstruction;
a noise removal and object detection unit configured for dynamic noise removal and object detection; and
an activity recognition unit configured for multi-dimensional activity recognition.

Embodiment 2. The system of embodiment 1, wherein the scanning and image reconstruction unit comprises
a controller intermittently controlling an external sonar device to perform low latency scanning to acquire sonar images.

Embodiment 3. The system of embodiment 2, wherein the scanning and image reconstruction unit comprises
a background removal device configured to eliminate static noises from the solar image acquired.

Embodiment 4. The system of embodiment 2, wherein the scanning and image reconstruction unit comprises
a signal reconstruction device configured to reconstruct the sonar images acquired to compensate for intermittent scanning.

Embodiment 5. The system of embodiment 1, wherein the noise removal and object detection unit comprises
a median filter configured to perform removal of high-frequency noises and extracting edges from the sonar images acquired.

Embodiment 6. The system of embodiment 1, wherein the activity recognition unit comprises a feature extractor configured for extracting multi-dimensional features from the sonar images acquired.

Embodiment 7. The system of embodiment 1, wherein the activity recognition unit comprises a monitor configured to monitor temporal states.

Embodiment 8. A sonar-based underwater sensing method, comprising:
performing intermittent scanning and image reconstruction;
performing dynamic noise removal and object detection; and
performing multi-dimensional activity recognition.

Embodiment 9. The system of embodiment 8, wherein the performing intermittent scanning and image reconstruction comprises intermittently controlling a sonar device to perform low latency scanning to acquire sonar images.

Embodiment 10. The system of embodiment 9, wherein the performing intermittent scanning and image reconstruction comprises eliminating static noises from the solar image acquired.

Embodiment 11. The system of embodiment 9, wherein the performing intermittent scanning and image reconstruction comprises performing reconstruction of the sonar images acquired to compensate for intermittent scanning.

Embodiment 12. The system of embodiment 8, wherein the performing dynamic noise removal and object detection comprises performing removal of high-frequency noises and extracting edges from the sonar images acquired.

Embodiment 13. The system of embodiment 8, wherein the performing multi-dimensional activity recognition comprises performing extracting multi-dimensional features from the sonar images acquired.

Embodiment 14. The system of embodiment 8, wherein the performing multi-dimensional activity recognition comprises monitoring temporal states.

Embodiment 15. A non-transitory computer readable medium having stored therein program instructions executable by a computing system to cause the computing system to perform a sonar-based underwater sensing method, the method comprising:
performing intermittent scanning and image reconstruction;
performing dynamic noise removal and object detection; and
performing multi-dimensional activity recognition.

Embodiment 16. The non-transitory computer readable medium of embodiment 15, wherein the performing intermittent scanning and image reconstruction comprises intermittently controlling a sonar device to perform low latency scanning to acquire sonar images.

Embodiment 17. The non-transitory computer readable medium of embodiment 16, wherein the performing intermittent scanning and image reconstruction comprises eliminating static noises from the solar image acquired.

Embodiment 18. The non-transitory computer readable medium of embodiment 16, wherein the performing intermittent scanning and image reconstruction comprises performing reconstruction of the sonar images acquired to compensate for intermittent scanning.

Embodiment 19. The non-transitory computer readable medium of embodiment 15, wherein the performing dynamic noise removal and object detection comprises performing removal of high-frequency noises and extracting edges from the sonar images acquired.

Embodiment 20. The non-transitory computer readable medium of embodiment 15, wherein the performing multi-dimensional activity recognition comprises performing extracting multi-dimensional features from the sonar images acquired.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1]2023. BlueRbotics. https://bluerobotics.com/store/sensors-sonarscameras/sonar/ping360-sonar-ri-rp/.
[2]2023. bluerobotics. https://bluerobotics.com
[3]2024. Code for AquaScan. https://anonymous.4open.science/r/Underwater-Human-Activities-Monitoring-6BA7.
[4] Gaddi Blumrosen, Ben Fishman, and Yossi Yovel. 2014. Noncontact wideband sonar for human activity detection and classification. IEEE Sensors Journal 14, 11 (2014), 4043-4054.
[5] Antoni Burguera and Gabriel Oliver. 2016. High-resolution underwater mapping using side-scan sonar. PloS one 11, 1 (2016), e0146396.
[6] Tuochao Chen, Justin Chan, and Shyamnath Gollakota. 2023. Underwater 3D positioning on smart devices. In ACM SIGCOMM 2023.
[7] Enrique Coiras, Yvan Petillot, and DavidMLane. 2007. Multiresolution 3-D reconstruction from side-scan sonar images. IEEE Transactions on Image Processing 16, 2 (2007), 382-390.
[8] American Red Cross. 1995. Lifeguarding Today. Mosby Lifeline. https://books.google.com.hk/books?id=VJ7IqLw5A14C
[9] Aram Danielyan, Vladimir Katkovnik, and Karen Egiazarian. 2011. BM3D frames and variational image deblurring. IEEE Transactions on image processing 21, 4 (2011), 1715-1728.
[10] Jeffrey Donahue, Lisa Anne Hendricks, Sergio Guadarrama, Marcus Rohrbach, Subhashini Venugopalan, Kate Saenko, and Trevor Darrell. 2015. Long-term recurrent convolutional networks for visual recognition and description. In Proceedings of the IEEE conference on computer vision and pattern recognition. 2625-2634.
[11] Martin Ester, Hans-Peter Kriegel, Jorg Sander, Xiaowei Xu, et al. 1996. A density-based method for discovering clusters in large spatial databases with noise. In kdd, Vol. 96. 226-231.
[12] Linwei Fan, Fan Zhang, Hui Fan, and Caiming Zhang. 2019. Brief review of image denoising techniques. Visual Computing for Industry, Biomedicine, and Art 2, 1 (2019), 7.
[13] Yihan Feng, Yaoguang Wei, Shuo Sun, Jincun Liu, Dong An, and Jia Wang. 2023. Fish abundance estimation from multi-beam sonar by improved MCNN. Aquatic Ecology 57, 4 (2023), 895-911.
[14] USA Centers for Disease Control and Prevention. 2024. Drowning Facts|Drowning Prevention. https://www.cdc.gov/drowning/facts/index.html.
[15] Cheryl D Fryar, Margaret D Carroll, Qiuping Gu, Joseph Afful, and Cynthia L Ogden. 2021. Anthropometric reference data for childrenand adults: United States, 2015-2018. (2021).
[16] .guinnessworldrecords. 2023. The Longest waistline. https://www.guinnessworldrecords.com/world-records/67531-largest-waist
[17] Upulie Handalage, Nisansali Nikapotha, Chanaka Subasinghe, Tereen Prasanga, Thusithanjana Thilakarthna, and Dharshana Kasthurirathna. 2021. Computer vision enabled drowning detection system. In 2021 3rd International Conference on Advancements in Computing (ICAC). IEEE, 240-245.
[18] Tim Hansen and Andreas Birk. 2023. Synthetic Scan Formation for Underwater Mapping with Low-Cost Mechanical Scanning Sonars (MSS). IEEE Access (2023).
[19] Alex E Hay and Douglas J Wilson. 1994. Rotary sidescan images of nearshore bedform evolution during a storm. Marine Geology 119, 1-2 (1994), 57-65.
[20] Kaiming He, Xinlei Chen, Saining Xie, Yanghao Li, Piotr Dollir, and Ross Girshick. 2022. Masked autoencoders are scalable vision learners. In Proceedings of the IEEE/CVF conference on computer vision and pattern recognition. 16000-16009.
[21] Kaiming He, Xiangyu Zhang, Shaoqing Ren, and Jian Sun. 2016. Deep residual learning for image recognition. In Proceedings of the IEEE conference on computer vision and pattern recognition. 770-778.
[22] Lixing He, Haozheng Hou, Zhenyu Yan, and Guoliang Xing. 2022. Demo Abstract: An Underwater Sonar-Based Drowning Detection System. In 2022 21st ACM/IEEE International Conference on Information Processing in Sensor Networks (IPSN). 493-494. https://doi.org/10.1109/IPSN54338.2022.00047
[23] Nobuhiro Hiranoa, Kosuke Onishia, and Seiichi Serikawaa. 2016. Suggestion of High Precision Drowning Detection System Using Plural Radio Modules. (2016).
[24] Hiroumi HORIMOTO, MAKI Toshihiro, Kazuya KOFUJI, and Takashi ISHIHARA. 2018. Autonomous sea turtle detection using multibeam imaging sonar: Toward autonomous tracking. In 2018 IEEE/OES Autonomous Underwater Vehicle Workshop (AUV). IEEE, 1-4.
[25] Haochen Hu, Zhi Sun, and Lu Su. 2020. Underwater motion and activity recognition using acoustic wireless networks. In ICC 2020-2020 IEEE International Conference on Communications (ICC). IEEE, 1-7.
[26] Thomas Huang, GJTGY Yang, and Greory Tang. 1979. A fast two-dimensional median filtering algorithm. IEEE transactions on acoustics, speech, and signal processing 27, 1 (1979), 13-18.
[27] Kohji Iida, Rika Takahashi, Yong Tang, Tohru Mukai, and Masanori Sato. 2006. Observation of marine animals using underwater acoustic camera. Japanese Journal of Applied Physics 45, 5S (2006), 4875.
[28] Ulf Jensen, Franziska Prade, and Bjoern M Eskofier. 2013. Classification of kinematic swimming data with emphasis on resource consumption. In 2013 IEEE International Conference on Body Sensor Networks. IEEE, 1-5.
[29] Jia-Xian Jian and Chuin-Mu Wang. 2021. Deep learning used to recognition swimmers drowning. In 2021 IEEE/ACIS 22nd International Conference on Software Engineering, Artificial Intelligence, Networking and Parallel/Distributed Computing (SNPD). IEEE, 111-114.
[30]H Paul Johnson and Maryann Helferty. 1990. The geological interpretation of side-scan sonar. Reviews of Geophysics 28, 4 (1990), 357-380.
[31] Chanho Kim, Fuxin Li, Arridhana Ciptadi, and James M Rehg. 2015. Multiple hypothesis tracking revisited. In Proceedings of the IEEE international conference on computer vision. 4696-4704.
[32] Diederik P Kingma. 2013. Auto-encoding variational bayes. arXiv preprint arXiv:1312.6114 (2013).
[33] Masahiro Kobayashi, Yuto Omae, Kazuki Sakai, Akira Shionoya, Hirotaka Takahashi, Takuma Akiduki, Kazufumi Nakai, Nobuo Ezaki, Yoshihisa Sakurai, and Chikara Miyaji. 2018. Swimming motion classification for coaching system by using a sensor device. ICIC Express Letters Part B: Applications 9, 3 (2018), 209-217.
[34] Hovannes Kulhandjian, Narayanan Ramachandran, Michel Kulhandjian, and Claude D'Amours. 2019. Human Activity Classification in Underwater using Sonar and Deep Learning. In Proceedings of the International Conference on Underwater Networks & Systems. 1-5.
[35] Aboli Kulkarni, Kshitij Lakhani, and Shubham Lokhande. 2016. A sensor based low cost drowning detection system for human life safety. In 2016 5th International Conference on Reliability, Infocom Technologies and Optimization (Trends and Future Directions)(ICRITO). IEEE, 301-306.
[36] Min Li, Houwei Ji, XiangcunWang, LiyuanWeng, and Zhenbang Gong. 2013. Underwater object detection and tracking based on multi-beam sonar image processing. In 2013 IEEE International Conference on Robotics and Biomimetics (ROBIO). 1071-1076. https://doi.org/10.1109/ROBIO.2013.6739606
[37] Jie Lian, Xu Yuan, Ming Li, and Nian-Feng Tzeng. 2021. Fall Detection via Inaudible Acoustic Sensing. Proceedings of the ACM on Interactive, Mobile, Wearable and Ubiquitous Technologies 5, 3 (2021), 1-21.
[38] Wen-Hung Liao, Zhung-Xun Liao, and Ming-Je Liu. 2003. Swimming style classification from video sequences. In 16th IPPR Conference on Computer Vision, Graphics and Image Processing, Kinmen, R. OC.
[39] Qiongzheng Lin, Zhenlin An, and Lei Yang. 2019. Rebooting ultrasonic positioning systems for ultrasound-incapable smart devices. In The 25th Annual International Conference on Mobile Computing and Networking. 1-16.
[40] Tony Lindeberg. 2024. Discrete approximations of Gaussian smoothing and Gaussian derivatives. Journal of Mathematical Imaging and Vision (2024), 1-42.
[41]J Macqueen. 1967. Some methods for classification and analysis of multivariate observations. In Proceedings of 5-th Berkeley Symposium on Mathematical Statistics and Probability/University of California Press.
[42] Yann Marcon, Eberhard Kopiske, Tom Leymann, Ulli Spiesecke, Vincent Vittori, Till von Wahl, Paul Wintersteller, Christoph Waldmann, and Gerhard Bohrmann. 2019. A Rotary Sonar for Long-Term Acoustic Monitoring of Deep-Sea Gas Emissions. In OCEANS 2019—Marseille. 1-8. https://doi.org/10.1109/OCEANSE.2019.8867218
[43] Danilo Navarro, Gines Benet, and Milagros Martinez. 2007. Line based robot localization using a rotary sonar. In 2007 IEEE Conference on Emerging Technologies and Factory Automation (EFTA 2007). IEEE, 896-899.
[44] Yuto Omae, Yoshihisa Kon, Masahiro Kobayashi, Kazuki Sakai, Akira Shionoya, Hirotaka Takahashi, Takuma Akiduki, Kazufumi Nakai, Nobuo Ezaki, Yoshihisa Sakurai, et al. 2017. Swimming style classification based on ensemble learning and adaptive feature value by using inertial measurement unit. Journal of Advanced Computational Intelligence and Intelligent Informatics 21, 4 (2017), 616-631.
[45] Adam Paszke, Sam Gross, Francisco Massa, Adam Lerer, James Bradbury, Gregory Chanan, Trevor Killeen, Zeming Lin, Natalia Gimelshein, Luca Antiga, et al. 2019. Pytorch: An imperative style, highperformance deep learning library. Advances in neural information processing systems 32 (2019).
[46]A Pozo-Ruz, J L Martinez, and A Garcia-Cerezo. 1997. Integration of a rotary sonar in the mobile robot RAM-2. IFAC Proceedings Volumes 30, 7 (1997), 143-147.
[47] Muhammad Ramdhan, Muhammad Ali, Samura Ali, MY Kamaludin, et al. 2018. An early drowning detection system for internet of things (iot) applications. TELKOMNIKA (Telecommunication Computing Electronics and Control) 16, 4 (2018), 1870-1876.
[48] Defence Research and Development Canada. [n. d.]. The safety of diver exposure to ultrasonic imaging sonars. https://publications.gc.ca/collections/collection_2018/rddc-drdc/D68-11-10-2018-eng.pdf.
[49] Olaf Ronneberger, Philipp Fischer, and Thomas Brox. 2015. U-net: Convolutional networks for biomedical image segmentation. In Medical image computing and computer-assisted intervention—MICCAI 2015: 18th international conference, Munich, Germany, Oct. 5-9, 2015, proceedings, part III 18. Springer, 234-241.
[50] Wenjie Ruan, Quan Z Sheng, Lei Yang, Tao Gu, Peipei Xu, and Longfei Shangguan. 2016. AudioGest: enabling fine-grained hand gesture detection by decoding echo signal. In Proceedings of the 2016 ACM international joint conference on pervasive and ubiquitous computing. 474-485.
[51] Ke Sun, Ting Zhao, Wei Wang, and Lei Xie. 2018. Vskin: Sensing touch gestures on surfaces of mobile devices using acoustic signals. In Proceedings of the 24th Annual International Conference on Mobile Computing and Networking. 591-605.
[52] Deividas Tarasevicius and Art uras Serackis. 2020. Deep learning model for sensor based swimming style recognition. In 2020 IEEE Open Conference of Electrical, Electronic and Information Sciences (eStream). IEEE, 1-4.
[53] Carlo Tomasi and Roberto Manduchi. 1998. Bilateral filtering for gray and color images. In Sixth international conference on computer vision (IEEE Cat. No. 98CH36271). IEEE, 839-846.
[54] Xiaofeng Tong, Lingyu Duan, Changsheng Xu, Qi Tian, and Hanqing Lu. 2006. Local motion analysis and its application in video based swimming style recognition. In 18th International Conference on Pattern Recognition (ICPR'06), Vol. 2. IEEE, 1258-1261.
[55] Mario Vittone. 2010. Drowning doesn't look like drowning. Repéré à http://mariovittone.com/2010/05/154 (2010).
[56] Ao Wang, Hui Chen, Lihao Liu, Kai Chen, Zijia Lin, Jungong Han, and Guiguang Ding. 2024. Yolov10: Real-time end-to-end object detection. arXiv preprint arXiv:2405.14458 (2024).
[57] Wikipedia. 2023. List of tallest people—Wikipedia, The Free Encyclopedia. https://en.wikipedia.org/wiki/List_of_tallest_people
[58] Haesang Yang, Sung-Hoon Byun, Keunhwa Lee, Youngmin Choo, and Kookhyun Kim. 2020. Underwater acoustic research trends with machine learning: Active SONAR applications. Journal of Ocean Engineering and Technology 34, 4 (2020), 277-284.
[59] Jing Yang, James P Wilson, and Shalabh Gupta. 2019. Diver gesture recognition using deep learning for underwater human-robot interaction. In Oceans 2019 Mts/Ieee Seattle. IEEE, 1-5.
[60] Qiang Yang and Yuanqing Zheng. [n. d.]. Neural Enhanced Underwater SOS Detection. Power (dB) 80, 60 ([n. d.]), 40.
[61] Qiang Yang and Yuanqing Zheng. 2023. AquaHelper: Underwater SOS Transmission and Detection in Swimming Pools. (2023).
[62] Zhijian Yang, Xiaoran Fan, Volkan Isler, and Hyun Soo Park. 2022. PoseKernelLifter: Metric Lifting of 3D Human Pose using Sound. In Proceedings of the IEEE/CVF Conference on Computer Vision and Pattern Recognition. 13179-13189.
[63] Chi Zhang, Xiaoguang Li, and Fei Lei. 2015. A novel camera-based drowning detection algorithm. In Chinese Conference on Image and Graphics Technologies. Springer, 224-233.
[64] Yi Zhang, Dasong Li, Xiaoyu Shi, Dailan He, Kangning Song, Xiaogang Wang, Hongwei Qin, and Hongsheng Li. 2023. Kbnet: Kernel basis network for image restoration. arXiv preprint arXiv:2303.02881 (2023).

We claim:

1. A sonar-based underwater sensing system, comprising:
a scanning and image reconstruction unit configured for intermittent scanning and image reconstruction;
a noise removal and object detection unit configured for dynamic noise removal and object detection; and
an activity recognition unit configured for multi-dimensional activity recognition.

2. The system of claim 1, wherein the scanning and image reconstruction unit comprises
a controller intermittently controlling an external sonar device to perform low latency scanning to acquire sonar images.

3. The system of claim 2, wherein the scanning and image reconstruction unit comprises
a background removal device configured to eliminate static noises from the solar image acquired.

4. The system of claim 2, wherein the scanning and image reconstruction unit comprises
a signal reconstruction device configured to reconstruct the sonar images acquired to compensate for intermittent scanning.

5. The system of claim 1, wherein the noise removal and object detection unit comprises
a median filter configured to perform removal of high-frequency noises and extracting edges from the sonar images acquired.

6. The system of claim 1, wherein the activity recognition unit comprises a feature extractor configured for extracting multi-dimensional features from the sonar images acquired.

7. The system of claim 1, wherein the activity recognition unit comprises a monitor configured to monitor temporal states.

8. A sonar-based underwater sensing method, comprising:
performing intermittent scanning and image reconstruction;
performing dynamic noise removal and object detection; and
performing multi-dimensional activity recognition.

9. The system of claim 8, wherein the performing intermittent scanning and image reconstruction comprises intermittently controlling a sonar device to perform low latency scanning to acquire sonar images.

10. The system of claim 9, wherein the performing intermittent scanning and image reconstruction comprises eliminating static noises from the solar image acquired.

11. The system of claim 9, wherein the performing intermittent scanning and image reconstruction comprises performing reconstruction of the sonar images acquired to compensate for intermittent scanning.

12. The system of claim 8, wherein the performing dynamic noise removal and object detection comprises performing removal of high-frequency noises and extracting edges from the sonar images acquired.

13. The system of claim 8, wherein the performing multi-dimensional activity recognition comprises performing extracting multi-dimensional features from the sonar images acquired.

14. The system of claim 8, wherein the performing multi-dimensional activity recognition comprises monitoring temporal states.

15. A non-transitory computer readable medium having stored therein program instructions executable by a computing system to cause the computing system to perform a sonar-based underwater sensing method, the method comprising:
performing intermittent scanning and image reconstruction;
performing dynamic noise removal and object detection; and
performing multi-dimensional activity recognition.

16. The non-transitory computer readable medium of claim 15, wherein the performing intermittent scanning and image reconstruction comprises intermittently controlling a sonar device to perform low latency scanning to acquire sonar images.

17. The non-transitory computer readable medium of claim 16, wherein the performing intermittent scanning and image reconstruction comprises eliminating static noises from the solar image acquired.

18. The non-transitory computer readable medium of claim 16, wherein the performing intermittent scanning and image reconstruction comprises performing reconstruction of the sonar images acquired to compensate for intermittent scanning.

19. The non-transitory computer readable medium of claim 15, wherein the performing dynamic noise removal and object detection comprises performing removal of high-frequency noises and extracting edges from the sonar images acquired.

20. The non-transitory computer readable medium of claim 15, wherein the performing multi-dimensional activity recognition comprises performing extracting multi-dimensional features from the sonar images acquired.
